(19) United States
(12) Patent Application Publication
(10) Pub. No.: US 2026/0029099 A1
(43) Pub. Date: Jan. 29, 2026

(54) Optical solid body made of a solid transparent material and method for producing same

(71) Applicant: Marelli Germany GmbH, Reutlingen (DE)

(72) Inventors: Armin AUSTERSCHULTE, Reutligen (DE); Johannes MANZ, Reutligen (DE); Anja LÖHLE, Reutligen (DE)

(21) Appl. No.: 19/279,502

(22) Filed: Jul. 24, 2025

(30) Foreign Application Priority Data
Jul. 29, 2024 (DE) 102024121468.6

(51) Int. Cl. F21S 41/20

(52) U.S. Cl. CPC F21S 41/285

(57) ABSTRACT

An optical solid body made of a solid transparent material for use in a light module of a motor vehicle lighting device. The optical solid body comprises a light coupling-in portion, via which light from a light source of the motor vehicle lighting device can be coupled into the optical solid body, and a light coupling-out portion, via which at least part of the light coupled into the optical solid body is coupled out of the optical solid body, so that the coupled-out light serves to generate at least part of a light distribution of the motor vehicle lighting device in front of the motor vehicle. The optical solid body further comprises an optically active layer arranged in the beam path between the coupling-in portion and the coupling-out portion, which is designed to modify incident light, wherein the optically active layer comprises at least one film.

### CROSS-REFERENCE TO RELATED APPLICATION

This application claims priority pursuant to 35 U.S.C. 119(a) to German Patent Office application Ser. No. 102024121468.6, filed Jul. 29, 2024, which application is incorporated herein by reference in its entirety.

### FIELD

The present invention relates to an optical solid body made of a solid transparent material for use in a light module of a motor vehicle lighting device. The optical solid body comprises a light coupling-in portion, via which light from a light source of the motor vehicle lighting device can be coupled into the optical solid body, and a light coupling-out portion, via which at least a portion of the light coupled into the optical solid body is coupled out of the optical solid body, so that the coupled-out light serves to generate at least a portion of a light distribution of the motor vehicle lighting device in front of the motor vehicle. Furthermore, the optical solid body has an optically active layer arranged in the beam path between the coupling-in portion and the coupling-out portion, which is designed to modify incident light, wherein the optically active layer is formed in the interior of the optical solid body.

In addition, the invention relates to a method for producing such an optical solid body.

Furthermore, the present invention relates to a light module of a motor vehicle lighting device, with a light source and such an optical solid body, wherein the light source is designed and arranged and aligned with respect to the optical solid body such that it emits light in a main emission direction in the direction of a light coupling-in portion of the optical solid body, and wherein the optical solid body is designed to modify light coupled into the optical solid body via the coupling-in portion by means of an optically active layer comprising at least one film, onto which at least part of the coupled-in light impinges, so that light coupled out via a coupling-out portion of the optical solid body generates at least part of a light distribution of the motor vehicle lighting device in front of the motor vehicle.

Finally, the invention also relates to a motor vehicle lighting device having a housing which has a light exit opening closed by a cover plate and, inside the housing, a light module which projects light in front of the motor vehicle to generate a light distribution of the motor vehicle lighting device or a part thereof. The motor vehicle lighting device is preferably designed as a motor vehicle headlight.

### BACKGROUND

Light modules with such optical solid bodies are known from the prior art in various embodiments. They have the advantage that they can be designed to be particularly small. In addition, they are inexpensive to manufacture, since an alignment and adjustment of various components of the light module relative to each other (e.g. primary lens or reflector relative to mirror diaphragm) can be omitted due to the one-piece optical solid body.

From EP 1 357 333 A2, for example, a light module of the type mentioned above for use in a motor vehicle headlight is known. The optical solid body used has a coupling-in portion on its underside, which is situated opposite a light source of the light module in the form of an LED. Furthermore, the optical solid body has a primary optical portion with a reflection surface, which is arranged opposite the coupling-in portion on the upper side of the optical solid body. On the underside of the optical solid body, next to the coupling-in portion, there is arranged an optically active layer in the form of a horizontal mirror diaphragm. An intermediate image generated in an intermediate image plane at a front edge of the mirror diaphragm is projected in front of the vehicle by a projection lens of the light module as a low-beam light distribution of the motor vehicle headlight. The projection lens is formed separately from the optical solid body and is arranged in the beam path downstream of the coupling-out portion of the optical solid body. Both the primary lens portion and the mirror diaphragm are formed at an outer boundary surface of the optical solid body. With the known optical solid bodies only one type of light distribution can be generated, for example a low-beam light distribution as in EP 1 357 333 A2. A different type of light distribution, e.g. a high-beam distribution, must be generated by a different light module of the lighting device.

From DE 10 2022 101 928 A1, an optical solid body is known for use in a light module of a motor vehicle headlight of the type mentioned at the outset. In the case of the known optical solid body, the optically active layer can comprise a flexible film. During the production of the optical solid body, a transparent material is first injected into a mold and then the film is applied to it. In the process, the film takes on the shape of the cured transparent material to which it has been applied. The cured material forms a support structure, so to speak, which brings the film into a desired three-dimensional shape and holds it in this shape during the intended use of the optical solid body. Without a support structure the film does not have sufficient inherent rigidity to maintain a three-dimensional shape itself.

The disadvantages of the prior art are explained below using an example of a film designed as a mirror diaphragm. The mirror diaphragm is used to create a light-dark boundary for the vehicle lighting system. In the case of an essentially horizontal surface extent of the mirror diaphragm, the diaphragm serves to create a light-dark boundary with an approximately horizontal course. Below the light-dark boundary, the low-beam light distribution illuminates a lane in front of the vehicle, while hardly any light reaches above the light-dark boundary, in order to prevent dazzling oncoming road users or those traveling in front of the home vehicle.

Depending on the type of traffic, the course of the light-dark boundary may vary. For example, a European standard provides for a so-called asymmetrical light-dark boundary, which provides for a first horizontal portion on the vehicle's own traffic side, a second portion on the oncoming traffic side which is also horizontal but lies below the first horizontal portion, and an oblique transition between the two horizontal portions. According to a Japanese standard, a vertical transition is provided between the two horizontal portions. It is understood that the described course of the light-dark boundary is not limited to the countries mentioned but may also be used in other countries. Furthermore, light modules are conceivable which have an optical solid body with a mirror diaphragm which is designed to produce an at least approximately horizontal light-dark boundary. This is particularly the case with light modules that generate only a part of the light distribution of the motor vehicle headlight. Different courses of the light-dark boundary or designs of the three-dimensional structure of the mirror diaphragm depending on the type of traffic can also arise in the case of right-hand and left-hand traffic.

The optically active layer formed as a film can be responsible for, or influence, not only the course of a light-dark boundary but also other properties of the resulting light distribution. For example, it is conceivable that overhead illumination values of a resulting low-beam light distribution and/or optical interference effects in the region of a vertical and/or horizontal light-dark boundary of a light distribution could be influenced.

A traffic-type-compliant design of the light module or of the optical solid body therefore depends on the shape, configuration and/or three-dimensional structure of the film. If, for example, in the prior art the type or design of a light-dark boundary of the resulting light distribution of the motor vehicle headlight is to be adapted to a different type of traffic, changes will have to be made to the mold or different mold inserts be used in order to give the injected transparent material, to which the flexible film is then applied, a correct shape that depends on the type of traffic in which the motor vehicle headlight with the light module with the optical solid body is intended for use. In order to be able to produce optical solid bodies for different types of traffic, in the prior art different molds or mold inserts are required. The production of the well-known optical solid bodies is therefore complex and cost-intensive even for one type of traffic, and in particular for different types of traffic.

In the prior art, different molds must be used to adapt the light module or the motor vehicle headlight to the type of traffic, which often requires multiple production of very similar molds, or mold inserts must be kept in stock, which requires retooling the mold for the production and adaptation of optical attachments to different types of traffic.

Proceeding from the described prior art, the present invention is therefore based on the object of making the production of known optical solid bodies, in particular for different types of traffic, simpler and more flexible.

This object is achieved by an optical solid body having the features of claim 1. Proceeding from the optical solid body of the type mentioned at the outset, it is proposed that the at least one film has a three-dimensional shape, configuration and/or structure and is overmolded with the transparent material of the optical solid body on at least one of its surfaces.

When manufacturing the optical solid bodies for the same type of traffic, but for different types of traffic, no changes to the mold and no alternative mold inserts are necessary. Due to the three-dimensional shape, configuration and/or structure of the film, it can be used instead of a mold insert and fulfills its function. The film therefore already has its desired three-dimensional shape, configuration and/or structure before it is inserted into the mold and retains this even after it has been inserted into the mold and during the injection of the transparent material into the mold. The optical solid bodies according to the invention can be manufactured more simply and flexibly, at least in the region that is responsible or relevant for a traffic-type-compliant design of the resulting light distribution. A further advantage is the reduced effort in mold production, since only one mold and no inserts are required, so that much faster changeovers are possible without significant set-up times.

The film inserted into the mold is overmolded on at least one of its surfaces with the transparent material of the optical solid body. After curing, the transparent material has on the side bounded by the film a shape, configuration and/or structure that is defined by the three-dimensional shape, configuration and/or structure of the film.

### SUMMARY

The invention relates to an optical solid body made of a solid transparent material for use in a light module of a motor vehicle lighting device. The optical solid body comprises a light coupling-in portion, via which light from a light source of the motor vehicle lighting device can be coupled into the optical solid body, and a light coupling-out portion, via which at least part of the light coupled into the optical solid body is coupled out of the optical solid body, so that the coupled-out light serves to generate at least part of a light distribution of the motor vehicle lighting device in front of the motor vehicle. The optical solid body further comprises an optically active layer arranged in the beam path between the coupling-in portion and the coupling-out portion, which is designed to modify incident light, wherein the optically active layer comprises at least one film and is arranged in the interior of the optical solid body. It is proposed that the at least one film has a three-dimensional shape, configuration and/or structure and is overmolded with the transparent material of the optical solid body on at least one of its surfaces.

In the present invention, the optically active layer is formed or arranged within the optical solid body. In other words, the optically active layer is surrounded at least on one side, preferably on all sides, by the transparent material of the optical solid body. This opens up completely new possibilities for a multifunctional optical solid body that is as small as possible, which will be explained in detail below.

The light source emits light in one main direction of radiation. The main radiation direction can be oriented parallel, obliquely or perpendicularly to an axis, e.g. an optical axis, of the optical solid body. When oriented slightly obliquely or parallel to the optical axis, the light coupled into the optical solid body can be directed directly towards the optically active layer in the optical solid body and does not have to be deflected in the optical solid body on its way there. In the case of an orientation that is highly oblique or perpendicular to the optical axis, it can be necessary for the optical solid body to have a primary optical portion that is designed to bundle at least a portion of the light coupled into the optical solid body and/or to redirect it in the direction of the optically active layer of the optical solid body. The primary optical portion can comprise a reflection surface formed externally on an outer boundary surface of the optical solid body, preferably opposite the coupling-in portion. Alternatively, the primary lens portion can also be formed or arranged by an optically active layer, in particular a reflective layer, in the interior of the optical solid body. It is conceivable for the optical solid body to have a plurality of optically active layers. These can have the same or different functions. However, the primary lens portion can also be arranged on the coupling-in portion or formed by it. The primary lens portion can be designed as a convergent lens portion that focuses light rays passing through and/or deflects them in the direction of the optical axis.

The invention makes it possible to produce an optically active layer within an optical solid body for the realization of a diaphragm, in particular also a mirror diaphragm, a spectral converter, a filter or the like. This makes a very compact design of multi-function light modules possible. Furthermore, the internal optically active layer can also be used to realize an internal demarcation of optical and non-optical regions of the optical solid body. The non-optical regions are available for other uses, e.g. as a fastening portion. Overall, installation effort can be reduced, since only one optical solid body with integrated diaphragm portion and/or integrated primary optical portion is required, instead of providing the diaphragm portion and/or primary optical portion as separate parts at an outer boundary surface of the optical solid body, and the functional integration can be increased by partial or complete separation of the light paths.

The optical solid body is made of a solid transparent material, e.g. glass or plastic, in particular PC or PMMI due to its good temperature stability. However, PMMA could also be used as a material if the temperatures within the optical solid body can be limited. A light-emitting semiconductor element, in particular an LED (light-emitting diode) or an LD (laser diode), is preferably used as the light source. Of course, a plurality of light sources can be assigned to a single optical solid body and can couple light into the optical solid body simultaneously, individually, or in groups.

A variety of different designs and/or functions of the optically active layer are conceivable. For example, the optical effective layer can assume the function of a diaphragm portion, in particular a light-shielding diaphragm or a mirror diaphragm, if designed accordingly. The invention makes it possible, among other things, to realize the function of a diaphragm, in particular a mirror diaphragm, within the optical solid body without having to rely on reflection at an outer boundary surface of the optical solid body.

The regions of the optical solid body behind the diaphragm which are shaded by the optically active layer, i.e. which no light reaches and which can therefore be referred to as non-optical regions, can take on non-optical tasks, e.g. can serve as a fastening portion for fastening the optical solid body or the light module in the lighting device or similar. This would not be possible in the prior art, since the diaphragm portion and/or the primary lens portion would be arranged externally on the boundary surface of the optical solid body.

In order to arrange a diaphragm inside the optical solid body, a film or a coating with absorbent and/or reflective properties can be introduced into the material of the optical solid body as an intermediate step during the production of the optical solid body, e.g. by means of a multi-layer injection-molding process or a multi-component multi-layer process. In particular, the film or coating can be applied to a partial optical solid body produced in a previous production step and then, in a subsequent step, overmolded or molded around with another layer of the material of the optical solid body.

According to an advantageous development of the invention, it is proposed that the design of the three-dimensional shape, configuration and/or structure depends on the type of traffic for which the motor vehicle lighting device, which has the light module with the optical solid body, is intended to be used. This means that the film can be shaped, designed and/or structured differently depending on the type of traffic for which the optical solid body or the light module equipped with it is intended to be used. To produce an optical solid body for a specific type of traffic, a specific film intended for this type of traffic only needs to be inserted into the mold and overmolded with the transparent material on at least one side of the film. To produce an optical solid body for a different type of traffic, a different film intended for the other type of traffic only needs to be inserted into the mold and overmolded with the transparent material on at least one side of the film. There is no need to change over the mold or to keep available and use different mold inserts.

According to a preferred embodiment of the invention, it is proposed that the three-dimensional shape, configuration and/or structure is designed for one of the following types of traffic or for the realization of one of the following lighting functions: right-hand traffic, left-hand traffic, targeted reduction of luminous intensity in regions of the light distribution of legal measuring points, and targeted increase of luminous intensity in regions of a low-beam light distribution above a horizontal light-dark boundary of the light distribution. In addition, the different traffic types can also include films for generating or forming a legally prescribed, defined or regulated light distribution for different countries or regions. In particular, the films are used to generate or form a main light distribution of a light module of a motor vehicle headlight. Such a main light distribution is, for example, low beam, high beam, a variable light distribution, city light, country road light, highway light, partial high beam or a part thereof, e.g. a low-beam or high-beam spot light or a low-beam or high-beam base light.

It is proposed that a main surface extent of the film with the three-dimensional shape, configuration and/or structure extends along or parallel to an axis of the optical solid body, preferably along a longitudinal axis or an optical axis of the optical solid body. Of course, it would also be conceivable for the main surface extent of the film to extend obliquely or perpendicularly to the axis of the optical solid body.

Advantageously, the at least one film with the three-dimensional shape, configuration and/or structure has a main surface extent which, in the case of a motor vehicle lighting device mounted in a motor vehicle and having the light module with the optical solid body, runs approximately parallel to a lane on which the motor vehicle is standing or traveling. In order to determine the main surface extent of the film, for example an imaginary interpolation plane can be set which best approximates the individual surface portions. According to this embodiment, this imaginary plane runs substantially or approximately parallel to the roadway, i.e. its surface extent runs approximately in a horizontal plane.

Of course, the film with the three-dimensional shape, configuration and/or structure could also have a main surface extent which, in the case of a motor vehicle lighting device mounted in a motor vehicle and having the light module with the optical solid body, runs other than approximately parallel to a lane on which the motor vehicle is standing or driving, i.e. for example, obliquely or perpendicularly thereto.

It is particularly preferred if the at least one film has an inherent rigidity such that it retains the designed three-dimensional shape, configuration and/or structure into which it was brought before being overmolded with the transparent material and which corresponds to the three-dimensional shape, configuration and/or structure of the overmolded film in the finished optical solid body. In this way, the film can be inserted into the mold as a replacement for one or more mold inserts, which significantly simplifies the production of the optical solid body, in particular the production of different optical solid bodies for different types of traffic.

It is particularly preferred if the at least one film is designed as a mirror diaphragm which defines or generates a light-dark boundary of a low-beam light distribution of the motor vehicle lighting device in front of the motor vehicle. The mirror diaphragm has a metallization layer at least on the surface facing the light coupling-in portion of the optical solid body. At this point, light entering the optical solid body is reflected or mirrored. Alternatively, the surface of the mirror diaphragm facing the light coupling-in portion of the optical solid body could also be designed and arranged in the optical solid body in such a way that incident light is totally reflected. The light reflected at the mirror diaphragm is coupled out of the optical solid body via the coupling-out portion and reaches an illuminated region of the light distribution, or in the case of a low-beam light distribution a region below the light-dark boundary. An edge of the mirror diaphragm, preferably a front edge (if the surface extent of the mirror diaphragm is along an axis of the optical solid body, in particular along the longitudinal or optical axis) or an upper edge (if the surface extent of the mirror diaphragm is perpendicular to the axis of the optical solid body), defines the location and course of the light-dark boundary.

However, it would also be conceivable for the at least one film or at least the surface of the film facing the coupling-in portion of the optical solid body to have light-scattering properties. In this case, the film can scatter the incident light either stochastically or selectively. In this way, excessively high luminous intensity values can be avoided in certain regions of the light distribution by redirecting the light to other illuminated regions of the light distribution, or minimum luminous intensity values can be achieved by redirecting the light from regions where high luminous intensity is not required or desired to those regions of the light distribution where certain minimum luminous intensity values are to be achieved. The scattered light is still preferably available for generating the light distribution and is not lost.

According to a further preferred embodiment, it is proposed that the at least one film has a lower refractive index than the transparent material used for overmolding the at least one film. It is proposed that the at least one film has, at least on the surface facing the light coupling-in portion of the optical solid body, a layer with a lower refractive index than the transparent material used for overmolding the at least one film. This allows the light coupled into the transparent material of the optical solid body to be influenced when it impinges on the layer with the lower refractive index. The transition from the transparent material to the layer with the lower refractive index forms a boundary surface. The light is preferably totally reflected at the boundary surface.

The object underlying the present invention is also achieved by a method having the features of claim 10. In particular, on the basis of the production method of the type mentioned above, it is proposed that the method comprises the following steps:
providing a film with a defined three-dimensional shape, configuration and/or structure,
coating at least a first surface of the film,
inserting the film into a mold, and
overmolding the first surface of the inserted film with the transparent material of the optical solid body.

The process has the advantage that the production of the optical solid body is particularly simple and flexible, since special mold inserts adjacent to or in the region of the film can be dispensed with. The film with the defined three-dimensional shape, configuration and/or structure itself replaces the mold insert or takes over its function. When manufacturing different optical solid bodies intended for use in different modes of transport, it is not necessary to convert the injection mold or make changes to the mold, nor to keep and use different mold inserts.

The first surface of the film is preferably a surface of the film facing the coupling-in portion of the optical solid body. The first surface of the film can be coated with a metallization layer (e.g. for a specular reflection of the incident light) and/or a layer with a lower refractive index than the transparent material used for overmolding the at least one film (e.g. for a total reflection). Of course, a coating with a layer with other properties, for example with light-scattering properties, would also be conceivable.

According to an advantageous development of the invention, it is proposed that after the first surface of the inserted film has been overmolded with the transparent material of the optical solid body, an oppositely situated second surface of the inserted film is also overmolded with the transparent material of the optical solid body. Since there is no need for separate mold inserts, which have to be removed again after the injection and curing of the transparent material, the overmolding of the two surfaces of the inserted film with the transparent material of the optical solid body can also take place simultaneously or at least partially overlapping in time.

More than one film can be arranged in the optical solid body. In this sense, it is proposed that a further film with a three-dimensional shape, configuration and/or structure is placed in the mold on top of the overmolded transparent material of the optical solid body and is overmolded with the transparent material of the optical solid body on at least one of its surfaces. The further film does not necessarily have to have an inherent rigidity such that it retains the designed three-dimensional shape, configuration and/or structure into which it was brought before being overmolded with the transparent material. The further film can be designed as a flexible film.

Advantageously, the three-dimensional shape, configuration and/or structure of the film is defined depending on the type of traffic for which the motor vehicle lighting device having the light module with the optical solid body is intended to be used. Preferably, the three-dimensional shape, configuration and/or structure is defined for one of the following traffic types or to realize one of the following lighting functions: right-hand traffic, left-hand traffic, targeted reduction of luminous intensity in regions of the light distribution of legal measuring points, and targeted increase of luminous intensity in regions of a low-beam light distribution above a horizontal light-dark boundary of the light distribution.

The object on which the present invention is based is also achieved by a light module having the features of claim 15. Starting from the light module of the type mentioned at the outset, it is proposed that the light module has an optical solid body according to the invention.

It is conceivable for the light module to have a plurality of light sources and/or a plurality of solid optical bodies. Light-emitting semiconductor elements, in particular LEDs or LDs, can be used as light sources. A plurality of light sources can be assigned to a single optical solid body and can couple light into the optical solid body simultaneously, individually or in groups. A plurality of light sources can be arranged and contacted on a common circuit board. A plurality of optical solid bodies can be designed as separate components or as a single integral component. A plurality of light sources and a plurality of optical solid bodies can be part of a matrix light module, wherein the partial light distributions of the individual optical solid bodies can complement and/or superimpose on each other to form the resulting light distribution of the motor vehicle lighting device. By selectively switching on/off or dimming the light sources assigned to the individual optical solid bodies, a variable light distribution can be created, e.g. a partial high-beam distribution. In a high-beam distribution, the regions where road users traveling in front or oncoming road users are detected are shaded by dimming or switching off the corresponding light sources, in order to prevent dazzling road users.

According to an advantageous development of the invention, it is proposed that the light module has a projection lens which is arranged downstream of the coupling-out portion of the optical solid body in the beam path and is designed to image an intermediate image formed in an intermediate image plane, which is preferably arranged in the optical solid body, as the light distribution of the motor vehicle lighting device or as part of the light distribution in front of the motor vehicle. The projection lens can be formed by the coupling-out portion of the optical solid body.

Finally, the object underlying the present invention is also achieved by a motor vehicle lighting device having the features of claim 18. Proceeding from the motor vehicle lighting device of the type mentioned at the outset, it is proposed that the motor vehicle lighting device has at least one light module according to the invention.

The motor vehicle lighting device in which the optical solid body according to the invention is used is not limited to a specific type of lighting device and can be designed, for example, as a headlight for generating a driving light or a main light distribution (e.g. low beam and/or high beam) or as a light for generating a lighting function, for example as a foglight for generating a fog light or as a cornering light for generating a curve or cornering light.

The at least one light module can be arranged rigidly or movably in the motor vehicle lighting device or its housing. It is conceivable for the at least one light module to be arranged pivotably in the housing of the lighting device. By specifically pivoting the at least one light module in the horizontal direction, a dynamic cornering light function can be realized. However, a horizontal pivoting of a light module can also be used to create a partial high beam. The partial high-beam distributions of two light modules each have a vertical light-dark boundary and are positioned relative to each other in such a way that other road users are located in a shaded region of the resulting light distribution between the two vertical light-dark boundaries. By specifically pivoting the at least one light module in the vertical direction, a dynamic headlight range control can be achieved. However, vertical pivoting of a light module can also be used to create a highway light by raising the light-dark boundary of a low-beam light distribution on highways, provided the traffic situation permits.

### BRIEF DESCRIPTION OF THE DRAWINGS

Further features and advantages of the present invention are explained in more detail below with reference to the figures. Features shown in the figures can also be essential to the invention on their own, even if this is not shown in the figures and not expressly mentioned in the description. Furthermore, a plurality of features shown in the figures can be combined with each other in any way, even if such a combination is not shown in the figures and is not expressly mentioned in the description. In the drawings:

FIG. 1 shows in a vertical longitudinal section a light module according to the invention for a motor vehicle lighting device according to a first exemplary embodiment, with an optical solid body according to the invention;

FIG. 2 shows in a horizontal longitudinal section the light module from FIG. 1;

FIG. 3 shows in a vertical longitudinal section a light module according to the invention for a motor vehicle lighting device according to a second exemplary embodiment, with an optical solid body according to the invention;

FIG. 4 shows in a horizontal longitudinal section the light module from FIG. 3;

FIG. 5 shows in a horizontal longitudinal section a light module according to the invention for a motor vehicle lighting device according to a third exemplary embodiment, with a plurality of solid optical bodies according to the invention;

FIG. 6 shows in a horizontal longitudinal section a light module according to the invention for a motor vehicle lighting device according to a fourth exemplary embodiment, with a plurality of solid optical bodies according to the invention;

FIG. 7 shows a view from the front into an optical solid body according to any one of FIG. 1 to FIG. 4 opposite a light exit direction;

FIG. 8 shows a first alternative embodiment of an optically active layer in the interior of an optical solid body according to FIG. 7;

FIG. 9 shows a second alternative embodiment of an optically active layer in the interior of an optical solid body according to FIG. 7;

FIG. 10 shows a motor vehicle lighting device according to the invention according to a preferred embodiment;

FIGS. 11a to 11c show various examples of structured films for the optical solid body for different types of traffic;

FIGS. 12a to 12d show various steps for producing the optical solid body according to the invention with a structured partially metallized film;

FIGS. 13a to 13b show various steps for producing the optical solid body according to the invention with a structured film with a low refractive index;

FIGS. 14a to 14b show various steps for producing the optical solid body according to the invention with a plurality of structured metallized films;

FIGS. 15a to 15b show various steps for producing the optical solid body according to the invention with a plurality of structured films with a low refractive index;

FIGS. 16a to 16b show various views of an optical solid body according to the invention with a structured film along an optical axis;

FIGS. 17a to 17b show various examples of structured films for the optical solid body for increasing or decreasing the luminous intensity in a resulting light distribution of the motor vehicle lighting device;

FIGS. 18a to 18c show various examples of structured films for the optical solid body for realizing crosstalk between a low-beam region and a high-beam region of a resulting light distribution of the motor vehicle lighting device;

FIG. 19 shows an example of structured films for the optical solid body for varying a resulting light distribution of the motor vehicle lighting device in the region of a transition between a low-beam region and a high-beam region of the resulting light distribution;

FIGS. 20a to 20b show various views of an optical solid body according to the invention with a structured film for Petzval adaptation; and,

FIG. 21 shows a flow diagram of a method according to the invention for producing an optical solid body according to the invention with a structured film.

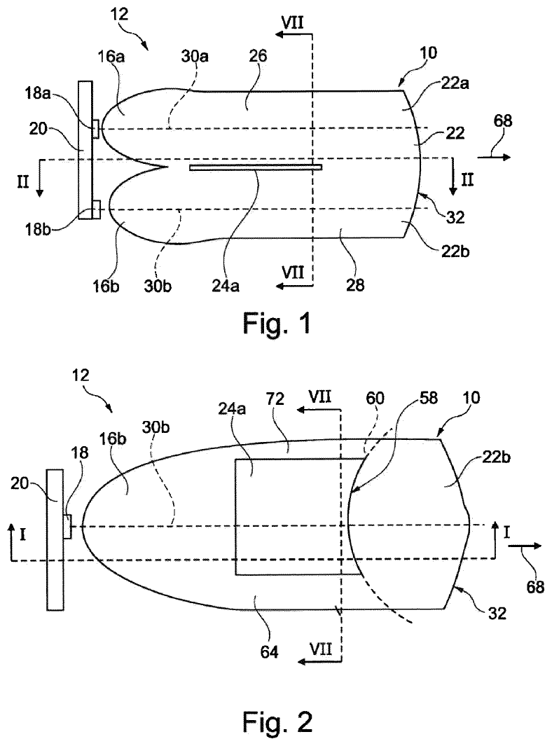

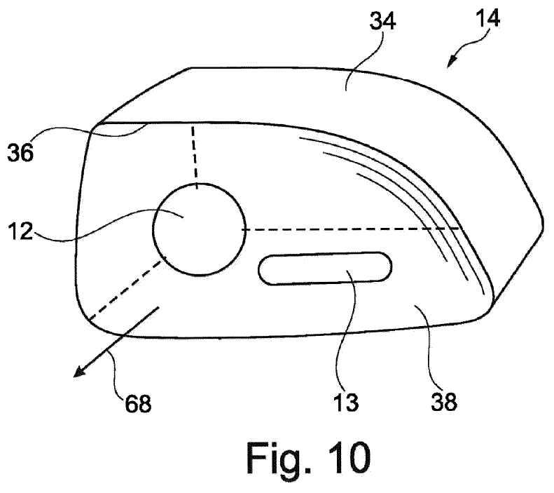

In FIG. 1, an optical solid body according to the invention is designated in its entirety by the reference sign 10. An optical solid body 10 is made of a solid transparent material. The material is, for example, glass or plastic, in particular PC or PMMI. The use of PMMA or another transparent plastic is also conceivable. The optical solid body 10 is designed as part of a light module 12 for use in a motor vehicle lighting device 14 (see FIG. 10).

In FIG. 10, a lighting device 14 according to the invention is shown in the form of a motor vehicle headlight. The lighting device 14 has a housing 34, which is preferably made of a plastic and comprises a light exit opening 36, which is closed by a transparent cover plate 38. The cover plate 38 is made of glass or plastic and can be formed with optically active elements (e.g. cylindrical lenses, prisms or similar) which scatter light passing through, in particular in a horizontal direction. Preferably, however, the cover plate 38 is designed as a so-called clear plate without optically active elements. The lighting device 14 is designed for installation in a corresponding installation opening of a motor vehicle. The light module 12 with an optical solid body 10 according to the invention is arranged inside the housing 34. A plurality of light modules 12 can also be arranged in the housing 34. Furthermore, it is conceivable for other light modules, symbolically represented in FIG. 10 by the reference sign 13, to be arranged inside the housing 34, which are designed for example to implement a lighting function (e.g. indicator light, cornering or curve light, daytime running light, position light, etc.) or at least part of a headlight function (e.g. low-beam base light, low-beam spotlight, high-beam base light, high-beam spotlight, etc.).

The motor vehicle lighting device 14 in which the optical solid body 10 according to the invention can be used is not limited to a specific type of lighting device and can be designed for example as a headlight for generating a driving light or a main light distribution (e.g. low beam, high beam, a variable light distribution, city light, country road light, highway light, partial high beam or a part thereof), as a foglight for generating a fog light, as a cornering light for generating a curve or cornering light or as a daytime running light for generating a daytime running light.

The optical solid body 10 comprises a light coupling-in portion 16, via which light from a light source 18 of the light module 12 can be coupled into the optical solid body 10. In the example of FIG. 1, the optical solid body 10 comprises two coupling-in portions 16a, 16b, each of which is assigned a light source 18a, 18b. In this example, the light sources 18a, 18b are each designed as a light-emitting semiconductor element, for example as an LED (light-emitting diode) or an LD (laser diode). The light sources 18a, 18b can be mounted on a common circuit board 20 and electrically contacted thereby. However, it would also be conceivable to use light-emitting semiconductor elements without a circuit board. Between the light sources 18 and the coupling-in portions 16, a bundling lens (so-called auxiliary lens) can be arranged (not shown), which bundles the light emitted by the particular light source 18 and directs it in the direction of the corresponding coupling-in portion 16. The bundling lens can, for example, consist of a catadioptric optical attachment in which the central part of the emitted light beam is bundled with a collecting lens and at least part of the remaining light enters the optical attachment via a surface extending substantially parallel to the optical axis and is bundled at a boundary surface of the optical attachment by means of total internal reflection (TIR).

Furthermore, the optical solid body 10 comprises a light coupling-out portion 22 via which at least a portion of the light coupled into the optical solid body 10 is coupled out of the optical solid body 10, so that the coupled-out light serves to generate at least a portion of a resulting light distribution of the motor vehicle lighting device 14 in front of the motor vehicle. Finally, the optical solid body 10 comprises an optically active layer 24 arranged in the beam path between the coupling-in portion 16 and the coupling-out portion 22, which layer is designed to modify incident light. In the context of the present invention, the optically active layer 24 comprises a film 24a with a three-dimensional shape, configuration and/or structure. A particular shape, configuration and/or structure of a mirror diaphragm is embossed into the film 24a.

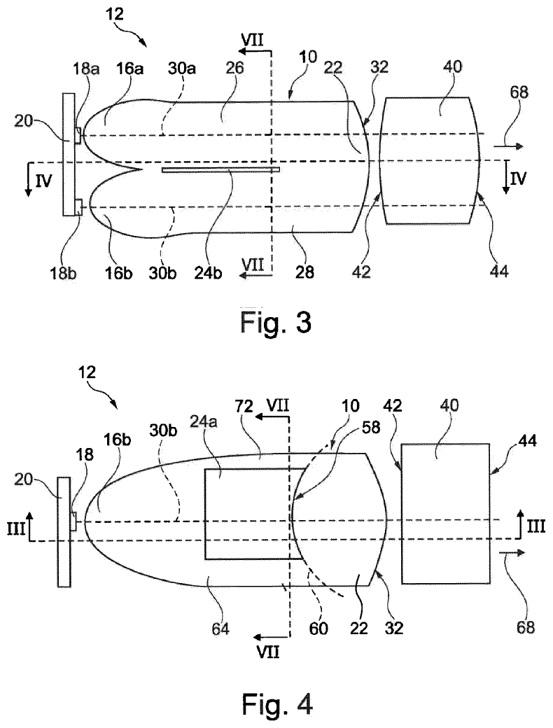

At least a part of the light coupled into the optical solid body 10 strikes the optically active layer 24 and is modified by it. In particular, an intermediate image is generated in an intermediate image plane by the optically active layer 24. The intermediate image plane is preferably located in the optical solid body 10. The intermediate image is projected in front of the vehicle by a secondary or projection lens (see FIGS. 3 and 4) to create the resulting light distribution. Preferably, the structured film 24a is designed to absorb, transmit, reflect, refract, diffract, spectrally convert and/or filter the incident light in whole or in part.

In the example shown here, the structured film 24a of the optical solid body 10 is arranged and designed such that it separates a first region 26 of the optical solid body 10, to which a first light source 18a of the light module 12 is assigned, from a second region 28 of the optical solid body 10, to which a second light source 18b of the light module 10 is assigned. Of course, it would also be conceivable to assign more than one light source 18 to each of the first and second regions 26, 28 of the optical solid body 10. The two regions 26, 28 of the optical solid body 10 preferably consist of the same solid optically transparent material, in particular of transparent material with the same refractive index.

In the example shown here, a common coupling-out portion 22 is assigned to the two regions 26, 28 of the optical solid body 10. However, it would also be conceivable to assign each of the regions 26, 28 a separate coupling-out portion 22a, 22b.

The structured film 24a can be completely flat or asymmetrical with a downward-sloping portion, as will be explained below. It lies on or runs parallel to an axis of the optical solid body 10, to an optical axis 30 or to two optical axes 30a, 30b of the first region 26 and of the second region 28 of the optical solid body 10. The structured film 24a is preferably used as a diaphragm that deflects incident light and thereby shades a specific region of the resulting light distribution where the shaded light would have reached without the diaphragm. In particular, the structured film 24a is designed as a mirror diaphragm which reflects incident light completely or partially in the direction of the coupling-out portion 22.

The first region 26 of the optical solid body 10 can for example be designed to generate a first light distribution of the illumination device 14, and the second region 28 can be designed to generate a second light distribution. The first light distribution is for example a low-beam light distribution with a horizontal light-dark border (e.g. fog light) or an almost horizontal (asymmetrical) light-dark border (e.g. low beam according to ECE). The first light distribution preferably by itself meets the legal requirements for low beam or fog light. However, it would also be conceivable for the first light distribution to meet the legal requirements for low-beam or fog light only in conjunction with another light distribution generated by another region of the optical solid body 10 or by another light module.

The second light distribution generated by the second region 28 illuminates, for example, a region of the light distribution above the light-dark boundary and, together with the low-beam light distribution of the first region 26 of the optical solid body 10, generates a high-beam light distribution. This preferably meets the legal requirements for high-beam light. However, it would also be conceivable for the second light distribution to meet the legal requirements for high beams only in conjunction with the low-beam light distribution of the first area 26 and another light distribution generated by another region of the optical solid body 10 or by another light module.

Each of the regions 26, 28 of the optical solid body 10 is assigned a coupling-in portion 16a, 16b facing the corresponding light source 18a, 18b and a coupling-out portion 22a, 22b. In this example, the two coupling-out portions 22a, 22b of the first and second regions 26, 28 of the optical solid body 10 are, as mentioned, combined to form a common coupling-out portion 22 or are formed by a single common coupling-out portion 22. The common coupling-out portion 22 of the optical solid body 10 can for example be designed as a lens.

In particular, the common coupling-out portion 22 has a convexly outwardly curved light exit surface 32.

A special feature of the present invention is that the structured film 24a is not formed or arranged on an outer boundary surface of the optical solid body 10, but rather within the solid body 10 itself. This makes it possible to realize particularly small optical solid bodies 10 and light modules 12. It is possible for the first time to realize two different light distributions, in particular low beam and high beam, through different regions 26, 28 of an optical solid body 10 designed as a one-piece component. In addition, the optical solid body 10 according to the invention is inexpensive to manufacture, since an alignment and adjustment of various components relative to one another (e.g. structured film 24a relative to coupling-in portion 16 and/or to coupling-out portion 22, or low-beam region 26 relative to high-beam region 28) can be omitted due to the one-piece design of the optical solid body 10.

In the example in FIGS. 1 and 2, the light coupling-out portion 22 simultaneously forms a secondary or projection lens, in particular a projection lens, which projects the intermediate image from the intermediate image plane in front of the motor vehicle as the resulting light distribution of the light module 12. This imaging effect is achieved in particular by the convexly outwardly curved light exit surface 32 of the coupling-out portion 22. The light exit surface 32 can be spherically or aspherically curved. An additional component in the form of the projection lens is thus integrated into the optical solid body 10. A complex arrangement and alignment of the solid body 10 relative to the projection lens during the production of the light module 12 or the lighting device 14 can be dispensed with. In addition, such a solution requires very little installation space.

In contrast, in the example in FIGS. 3 and 4 a separate secondary or projection lens 40 is arranged downstream of the coupling-out portion 22 of the optical solid body 10 in the beam path. In the example shown, the secondary or projection lens 40 is designed as a projection lens with a light entry surface 42 and a light exit surface 44. In the example shown, the projection lens 40 which is biconvex in the vertical section (cf. FIG. 3) is provided and has convex light entry surface 42 and convex light exit surface 44. In particular, the projection lens 40 is designed as a cylindrical lens (see FIG. 4). Other designs of the secondary or projection lens 40 are also conceivable. A separate secondary or projection lens 40 has the advantage that the refraction of the exiting light for imaging the intermediate image from the intermediate image plane in front of the motor vehicle can be divided as a light distribution onto a plurality of light transmission surfaces 32, 42, 44. This allows a high-resolution light distribution with greater accuracy and results in a greater degree of design freedom.

As a result of the novel optical solid body 10 with integrated structured film 24a, the secondary or projection lens 40 has a particularly short focal length, which can be for example in the range of only 50 mm (+/−20 mm). This is a very small value for a motor vehicle headlight 14, since the focal lengths of corresponding secondary or projection lenses of previously known headlights are in the range of at least 100 mm.

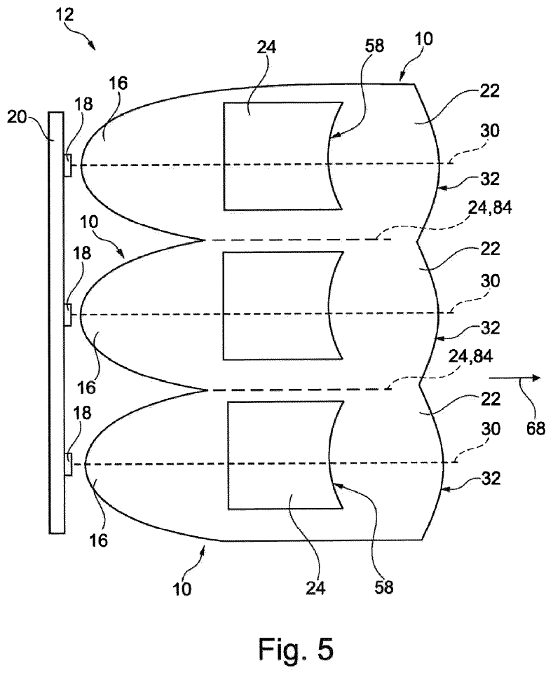

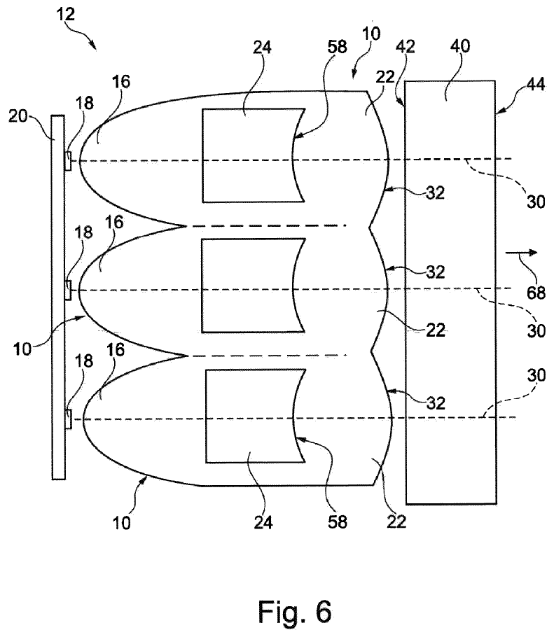

In the example in FIG. 5, the secondary or projection lens is integrated into the coupling-out portion 22 of the optical solid body 10. In particular, the function of the lens is taken over by the light exit surface 32 of the coupling-out portion 22. In contrast, in the example in FIG. 6 a separate secondary or projection lens 40 is provided. In a preferred embodiment, the common light exit surface is designed to be smooth and continuous, in particular having a continuous curvature.

In the examples in FIGS. 5 and 6, the optical axes 30 of the individual optical solid bodies 10 run parallel to each other. Of course, it would also be conceivable for the optical axes 30 to run obliquely to one another so that they intersect at least one intersection point, preferably at a common intersection point for the optical axes 30 of all optical solid bodies 10 of a light module 12.

In the examples in FIGS. 5 and 6, it is possible for light coupled into an optical solid body 10 of a light module 12 to reach an adjacent optical solid body 10 of the light module 12. This can have the advantage that the resulting light distribution is homogenized. On the other hand, such crosstalk of the light rays from one optical solid body 10 into an adjacent optical solid body 10 can also be disadvantageous, for example because it leads to scattered light that is difficult to control and/or because the realization of a preferably high-resolution light distribution is made more difficult. In this case, it can be advantageous to introduce structured films 24a into the common optical component which forms the optical solid bodies 10, in the form of separating walls 84 between individual or all optical solid bodies 10, which walls prevent crosstalk of the light beams (cf. FIG. 5). In this context, it is proposed that the separating walls 84 have reflective properties on both surfaces. If a low crosstalk of the light beams is desired, the separating walls 84 can be designed to be partially transparent. It is also advantageous if the separating walls 84 extend with a flat surface. The films 24a can be introduced into the optical component during the production of the common optical component according to the method of the invention.

The light sources 18 each emit light in the main direction of radiation. The main radiation direction can be aligned parallel, obliquely or perpendicular to the optical axis 30 of the optical solid body 10. In a preferred alignment slightly oblique or parallel to the optical axis 30 (cf. FIGS. 1 to 6 and FIG. 11), the light coupled into the optical solid body 10 can be directed directly in the direction of the structured film 24a of the optical solid body 10 and does not have to be deflected by the optical solid body 10 on its way there. In the case of an equally conceivable orientation which is highly oblique or perpendicular to the optical axis 30, it can be necessary for the optical solid body 10, as seen in the main direction of radiation of the light source 18, to have a primary optical portion situated opposite the coupling-in portion 16, which primary optical portion is designed to bundle at least a portion of the light coupled into the optical solid body 10 and/or to deflect it in the direction of the structured film 24a of the optical solid body 10. The primary lens portion can have a reflection surface that is formed or arranged in a conventional manner on an outer boundary surface of the optical solid body 10. Alternatively, the reflection surface forming the primary lens portion can also be formed by an optically active layer which, in the sense of the present invention, is formed or arranged in the interior of the optical solid body 10. It is therefore conceivable for the optical solid body 10 to also have a plurality of and/or different optically active layers 24.

An advantage of the present invention is the production of the structured film 24a within the optical solid body 10 for the realization of a diaphragm, in particular a mirror diaphragm, a spectral converter, a filter, or the like. This enables a very compact design of multi-function modules 12. Furthermore, the internal structured film 24a can also be used to create an internal demarcation of the optical solid body 10 between optically active regions and optically non-effective regions into which no light can penetrate because it is shaded by the structured film 24a. Overall, the installation effort can thus be reduced, since only one optical solid body 10 with integrated diaphragm arrangement is required, instead of an additional diaphragm arrangement, and the functional integration can be increased by the partial separation of light paths (cf. FIGS. 1 to 4).

The design and manufacture of the structured film 24a inside the optical solid body 10 is explained in more detail below. A variety of different designs and/or functions of the structured film 24a are conceivable. Thus, with appropriate design, the structured film 24a can, for example, assume the function of a diaphragm, in particular a mirror diaphragm (cf. FIGS. 1 to 6). The invention makes it possible, among other things, to realize the function of a mirror diaphragm within an optical solid body 10 without being dependent on reflection at an outer boundary surface of the solid body 10.

In order to arrange the structured film 24a inside the optical solid body 10, the structured film 24a with absorbing and/or reflective properties can be introduced into the material of the optical solid body 10 as an intermediate step during the production of the optical solid body 10, for example by a multi-layer injection-molding process or a multi-component multi-layer process. For this purpose, the film 24a is arranged in the mold and then overmolded on at least one side with a layer 26 of the transparent material of the optical solid body 10.

The film 24a has such a high inherent rigidity that it retains the three-dimensional shape, configuration and/or structure into which it was brought before insertion into the mold and overmolding with the transparent material, and which corresponds to the three-dimensional shape, configuration and/or structure of the overmolded film 24a in the finished optical solid body 10. In this way, the film 24a can be inserted into the mold as a replacement for one or more mold inserts, which significantly simplifies the production of the optical solid body 10, in particular the production of different optical solid bodies 10 for different types of traffic.

In a subsequent manufacturing step, the film 24a introduced into the mold can be coated or overmolded with a further layer 28 of the transparent material of the optical solid body 10.

The film 24a has a light-reflecting and/or light-absorbing surface at least on one side facing the light originating from the coupling-in portion 16. An absorbent surface can absorb at least part of the incident light and shade the absorbed part of the coupled-in light, thus forming a desired light distribution. The absorbent surface is for example matt, in particular matt black. Using such a shading diaphragm, it would be conceivable for example to create a shaded region of the light distribution. An edge of the diaphragm, in particular a front edge of a horizontal diaphragm, can be imaged by the secondary or projection lens 32, 40 as a light-dark boundary of the light distribution. The light-dark boundary runs along a transition between an illuminated region of the light distribution and a shaded region. The light-dark boundary can have a horizontal or almost horizontal (asymmetrical) course, for example to create a fog light or low beam (according to ECE) or part of it. Likewise, the light-dark boundary can have a vertical or almost vertical course, for example to create a partial high beam or a part thereof, in which regions of the light distribution in which other road users have been detected are shaded in order to avoid dazzling them.

A reflective surface of the structured film 24a can specifically reflect incident light (so-called specular reflection) in such a way that it is not lost but can contribute to the generation of the light distribution. As a result, a light distribution can be formed with a light-dark boundary and a shaded area above the light-dark boundary and an illuminated area below the light-dark boundary, which includes on the one hand the light that has passed the mirror diaphragm 24 and, on the other hand, also at least part of the light reflected by the mirror diaphragm 24. In this way, a particularly efficient low-beam light distribution can be created.

The structured film 24a can also be designed to be partially transparent, i.e. part of the light incident on the structured film 24a passes through the film 24a and another part of the light is absorbed and/or reflected by the film 24a. This has the advantage that the part of the light transmitted through the structured film 24a can reach the intrinsically shaded area of a low-beam light distribution, in particular above the light-dark boundary, and can be used there in the scope of the light distribution to realize special lighting tasks. In this way, for example, overhead lighting of a low beam can be realized above the light-dark boundary.

The structured film 24a introduced into the optical solid body 10 is preferably designed and shaped such that it generates an intermediate image in an intermediate image plane, which can be imaged by the secondary or projection lens 32 or 40 to generate the resulting light distribution in front of the motor vehicle. In particular, the structured film 24a is designed and shaped such that it generates an intermediate image in intermediate image plane 60 (cf. FIGS. 2 and 4), which intermediate image can be imaged by the secondary or projection lens 32 or 40 to generate a low-beam light distribution (e.g. low beam, fog light, cornering light) or a partial high beam in front of the motor vehicle. The intermediate image plane 60 is preferably located inside the optical solid body 10. Very particularly preferably, the intermediate image plane 60 is located at an edge 58, in particular at a front edge of a diaphragm arrangement 24 running along an optical axis 30; 30a, 30b of the optical solid body 10 or parallel thereto. This edge 58 can be imaged by the secondary or projection lens 32 or 40 as the light-dark boundary of the light distribution in front of the motor vehicle.

The front edge 58 and the intermediate image plane 60 can have a straight or flat course in a plan view (cf. FIGS. 2 and 4) (not shown). Preferably, however, the edge 58 and the intermediate image plane 60 have a curved course. The curved course preferably follows the focal points of the exit surface 32 or 44 of the coupling-out portion 22 or of the projection lens 40. This curved shape of the front edge 58 of the diaphragm 24 can be advantageous for correcting aberrations in the light distribution.

Furthermore, it would be conceivable to design the structured film 24a in such a way that it converts light of a first spectrum coupled into the optical solid body 10 completely or partially into light of a different spectrum, i.e. changes the color of the light. This can be achieved for example by the structured film 24a reflecting and/or absorbing only the light components of a specific frequency spectrum. In this context, it would be conceivable for example for the structured film 24a to be at least partially translucent and to have a specific color, for example red, green or blue, on its surface facing the coupling-in portion 16, in order to specifically change the color of the light of the resulting light distribution. The coloring on the surface of the structured film 24a can be applied for example by spraying, sputtering or vapor deposition of colorant. Changing the color of the light can be useful if the light source 18 used only emits light of a certain color, which cannot be easily changed at the light source 18 itself. Here, the structured film 24a with spectrally transforming properties offers an easily realizable possibility for color correction of the light of the resulting light distribution. Individual wishes of motor vehicle manufacturers regarding the color of the light for their vehicle headlights (some manufacturers prefer greenish white light for the headlight functions, while others prefer bluish or yellowish white light) can also be taken into account in this way, easily and cost-effectively.

Since only a part of the light coupled into the optical solid body 10 hits the structured film 24a and can thus be modified spectrally or in its color at all, the coloration of the light can only be slightly modified by the structured film 24a with spectrum-modifying properties. This means that, for example, daylight white light (over 5300 K) can be converted into warm white light (below 3300 K) with a relatively high yellow component or into cold white light (approx. 7000 to 9000 K) with a higher blue and/or green component.

Alternatively, or additionally, it would also be conceivable to design the structured film 24a in such a way that it has light-filtering properties. The film 24a only reflects incident light of a specific frequency spectrum. The remaining frequency spectrum of the light is transmitted or absorbed. The structured film 24a in the form of an optical filter can have a simple colorant coating or more complex alternatives, e.g. an interference filter. The interference filter can comprise one or more superimposed diffraction structures. The interference filter can however also comprise a plurality of partially translucent metallic mirror layers (e.g. made of silver, aluminum). The structured film 24a can have an optically filtering layer. Optionally, the film 24a comprises a transparent carrier layer onto which various layers are then applied, which realize the optically filtering effect of the light passing through and/or reflected.

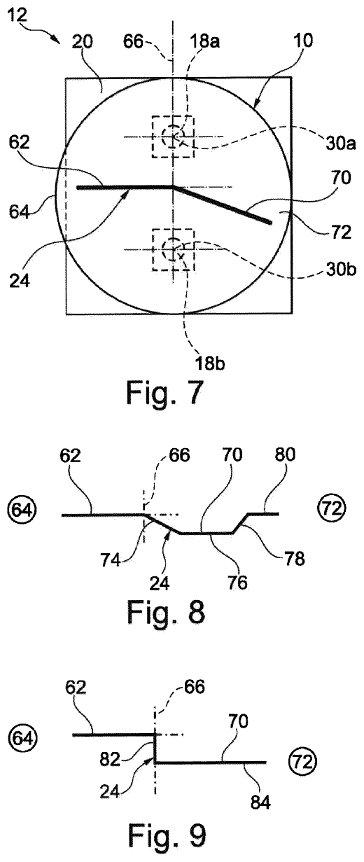

FIG. 7 shows a view into the optical solid body 10 according to any one of FIGS. 1 to 4, opposite a light exit direction 68. According to this embodiment, it is proposed that the structured film 24a has a first flat portion 62 which extends from one side 64 of the optical solid body 10 in the direction of a vertical center plane 66 of the optical solid body 10, in particular in the direction of the optical axis 30; 30a, 30b of the optical solid body 10. The horizontal portion 62 is arranged (viewed in the light exit direction 68) on the vehicle's own traffic side (right in the case of right-hand traffic; left in the case of left-hand traffic) of the vertical center plane 66. The flat portion 62 is used (after projection by the secondary or projection lens 32 or 40) for example to generate a horizontal portion of an asymmetrical light-dark boundary of a low beam according to ECE or of a low-beam spotlight. The horizontal portion of the light-dark boundary is arranged (viewed in the light exit direction 68) in front of the motor vehicle on the oncoming traffic side, in particular on the oncoming traffic lane.

The first portion 62 is followed by a portion 70 which slopes downwards, preferably at a 15° angle, and which is flat in a view opposite to the light exit direction 68. However, it would also be conceivable for the sloping portion 70 to be curved or even stepped (not shown). The sloping portion 70 extends in the direction of a second side 72, opposite the first side 64, of the optical solid body 10. The portion 70 is arranged (viewed in the light exit direction 68) on the oncoming traffic side of the vertical center plane 66. The sloping portion 70 is used (after projection by the secondary or projection lens 32 or 40) for example to generate a rising portion of an asymmetrical light-dark boundary of a low beam according to the ECE standard, or of a low-beam spotlight. The rising portion of the light-dark boundary is arranged (viewed in the light exit direction 68) in front of the motor vehicle on the vehicle's own side, in particular at the edge of the lane on the vehicle's own side and/or on the vehicle's own lane.

According to the example described, the structured film 24a, particularly when it is designed as a diaphragm or mirror diaphragm, thus has a planar extent with a bend along an optical axis 30; 30a, 30b or along an axis running parallel to an optical axis 30; 30a, 30b or along the center plane 66. The front edge 58 of the structured film 24a is, as already described above, preferably curved counter to the light exit direction 68. The front edge 58 of the structured film 24a thus extends further in the light exit direction 68 on the opposite sides 64, 72 than in the region of the vertical center plane 66 (cf. FIGS. 2 and 4), which runs through at least one of the optical axes 30a, 30b or parallel thereto.

In FIGS. 8 and 9, alternative embodiments of the structured film 24a opposite to the light exit direction 68 are shown. All have the flat portion 62 in common, but the design of the downward-sloping portion 70 differs from the example in FIG. 7. In the example in FIG. 8, the sloping portion 70 comprises a first partial portion 74 sloping downwards, preferably at a 15° angle, followed by a substantially horizontal second partial portion 76, followed in turn by a rising third partial portion 78 and finally by a flat fourth portion 80. The second partial portion 76 runs below the flat portion 62 and preferably parallel thereto. The third partial portion 78 can rise at a 15° angle or any other angle. The fourth partial portion 80 preferably runs at the same height as the flat portion 62 and is congruent or parallel thereto.

In the example in FIG. 9, the sloping portion 70 comprises a first partial portion 82 sloping preferably vertically downwards and adjoining it a substantially horizontal second partial portion 84. The second partial portion 84 runs below the flat portion 62 and preferably parallel thereto. The first partial portion 82 forms a stepped transition between the flat portion 62 and the second partial portion 84.

FIGS. 7 to 9 show the shape of the structured film 24a in the form of a diaphragm or mirror diaphragm for right-hand traffic. It is understood that in the case of left-hand traffic, the illustrated courses of the structured film 24a would be approximately mirrored at the vertical center plane 66.

In FIGS. 5 and 6, two embodiments of a light module 12 with a plurality of optical solid bodies 10 are shown. In the examples, three optical solid bodies 10 are arranged next to each other. Of course, more or fewer than three optical solid bodies 10 can be arranged next to each other. It would also be conceivable to arrange the illustrated optical solid bodies 10 or further optical solid bodies 10 one above the other and/or offset obliquely to one another. The arrangement of the optical solid bodies 10 depends on the installation space available in the motor vehicle (shape and size of the installation opening in the body) and/or on design specifications. The solid optical bodies 10 can be arranged next to one another on a horizontal plane or on a plane running obliquely to the horizontal plane, so that, viewed counter to the light exit direction 68, an ascending or descending course of the solid optical bodies 10 or their light exit surfaces 32 results.

The individual optical solid bodies 10 of a light module 12 are, as shown in FIGS. 5 and 6, preferably designed as a single jointly manufactured one-piece optical component. Alternatively, individual or all optical solid bodies 10 of such a light module 12 can be designed as separate optical components (not shown).

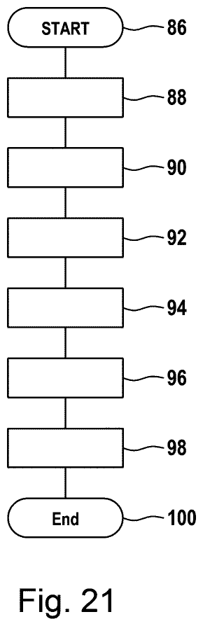

FIG. 21 shows a flow diagram of a method for producing an optical solid body 10 according to the invention with an internal structured film 24a. The process begins in a step 86.

Then, in a first method step 88 of the production process, which is for example a multi-layer injection-molding process, the structured film 24a is brought into a desired three-dimensional shape, configuration and/or structure. This can be done by pressure, which depending on the film material can be pressing, bending, or similar. It is conceivable to supply heat during the shaping of the structured film 24a in order to facilitate deformation of the film 24a and so that afterwards the film 24a retains the shape, configuration and/or structure into which it was formed. The film 24a preferably has such a high inherent rigidity that it retains the three-dimensional shape, configuration and/or structure into which it was brought before insertion into the mold and which corresponds to the three-dimensional shape, configuration and/or structure of the film 24a in the finished optical solid body 10.

In a subsequent method step 90, an optically active layer 24 can be applied to a surface of the structured film 24a which faces the light beams coupled in through the coupling-in portion 16. The optically active layer 24 is designed to modify incident light (e.g. reflecting, absorbing, scattering, etc.). The layer 24 can be a metallization layer, a layer with a lower refractive index than the transparent material used to overmold the at least one film 24a, or any other layer that can modify incident light. The layer 24 can be applied by sputtering, spraying, painting, vapor deposition, or similar.

It is conceivable to switch steps 88 and 90, so that the film 24a is first coated and only then brought into the desired three-dimensional shape, configuration and/or structure.

The design of the three-dimensional shape, configuration and/or structure of the structured film 24a depends on a type of traffic for which the motor vehicle lighting device 14, which has the light module 12 with the optical solid body 10, is intended to be used. The three-dimensional shape, configuration and/or structure of the structured film 24a is designed for one of the following types of traffic or to realize one of the following lighting functions: right-hand traffic, left-hand traffic, targeted reduction of luminous intensity in regions of the light distribution of legal measuring points, and targeted increase of luminous intensity in regions of a low-beam light distribution above a horizontal light-dark boundary of the light distribution.

Next, in a method step 92 the structured film 24a is inserted into a mold. The film 24a can be inserted into the mold as a replacement for one or more mold inserts, thereby significantly simplifying the production of the optical solid body 10, in particular the production of different optical solid bodies 10 for different types of traffic. In particular, different mold inserts for designing the optically active layer 24 for the different types of traffic do not need to be manufactured, kept in stock and inserted into the mold. In order to produce an optical solid body 10 for a specific type of traffic, a structured film 24a designed according to the type of traffic only needs to be inserted into the mold.

In a subsequent method step 94, the structured film 24a inserted into the mold is then overmolded with the transparent material of the optical solid body 10 on at least one of its surfaces. The structured film 24a here serves as a replacement for one or more mold inserts and can bring the injected transparent material in the regions adjacent to the film 24a into the desired shape of the optical solid body 10. Removing the mold insert after the injection molding or curing of the transparent material can also be dispensed with, since the film 24a remains in the finished optical solid body 10.

If desired, in a further method step 96 the structured film 24a inserted into the mold can be overmolded with the transparent material of the optical solid body 10 at least on another of its surfaces. Method steps 94 and 96 can also be carried out simultaneously or at least partially overlapping in time.

If desired, in a method step 98 further optically active layers 24 can be inserted into the mold onto the injected material of the optical solid body 10 and then overmolded with further transparent material of the optical solid body 10. This can be done in the manner according to the invention or in the manner described in DE 10 2022 101 928 A1.

The method ends in a step 100.

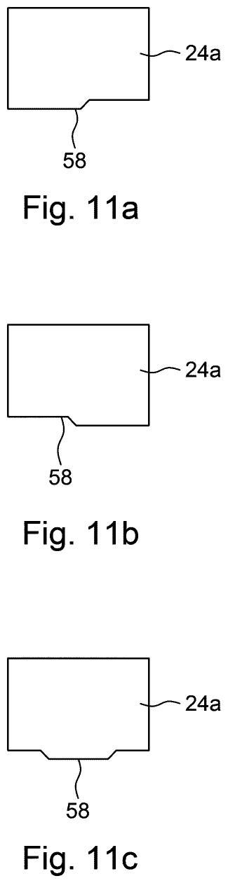

FIGS. 11a to 11c show, by way of example, various embodiments of a structured film 24a for different types of traffic, each in a plan view orthogonal to the optical axis 30; 30a, 30b of the optical solid body 10 into which they are inserted. The different traffic types include right-hand traffic (FIG. 11a) and left-hand traffic (FIG. 11b) as well as a lowering of the light distribution to the right and left of a vertical center plane of the light distribution combined with a raising at the lateral outer edges of the light distribution (FIG. 11c).

One aspect of the invention is to form a contour of the surface of the film 24a, which is responsible for the implementation of the traffic type of the optical solid body 10 and at which the reflection of the light coupled into the optical solid body 10 takes place, not by the implementation of the mold and the subsequent reflection by total internal reflection (TIR) but by inserting the structured film 24a, or a film package comprising a plurality of films 24a, which can have a refractive index different from the transparent injection-molding material of the optical solid body 10 or can have a metallization/mirroring in order to influence the incident light rays, in particular to reflect them.

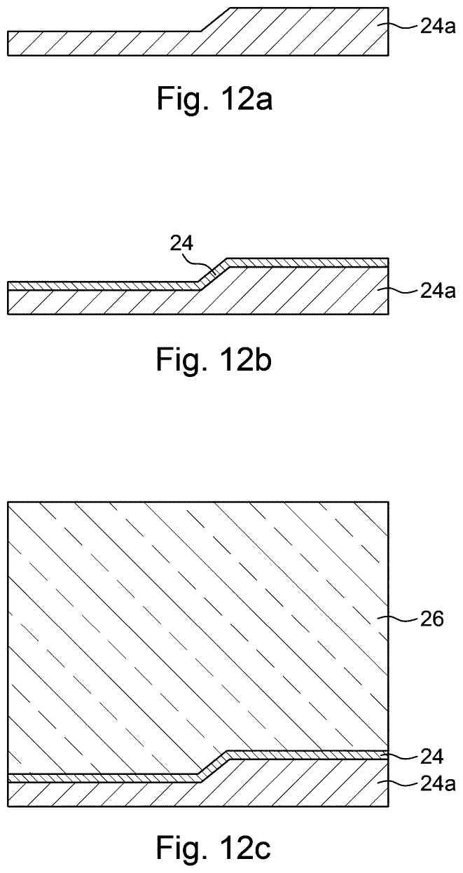

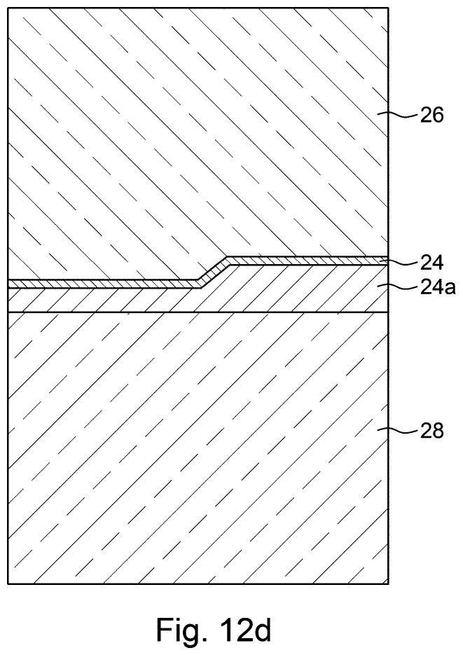

A possible embodiment for producing an optical solid body 10 with a structured, at least partially metallized film 24a comprises the following steps:
A. Production of a structured film 24a with the three-dimensional shape, configuration and/or structure (cf. FIG. 12a);
B. Metallization of at least one surface of the structured film 24a facing the coupling-in portion 16; 16a, 16b of the optical solid body 10 with a metallization layer 24 (cf. FIG. 12b); and
C. Insertion of the structured film 24a into the mold and then overmolding at least one side of the film 24a with the transparent material 26 of the optical solid body 10 (cf. FIG. 12c).
D. Optionally, the opposite side of the film 24a could also be overmolded with the transparent material 28 of the optical solid body 10 in a further work step in order to realize a new functionality, as described for example in DE 10 2022 101 928 A1 (cf. FIG. 12d). The transparent material 28 preferably has the same refractive index as the transparent material 26 on the opposite side of the film 24a.

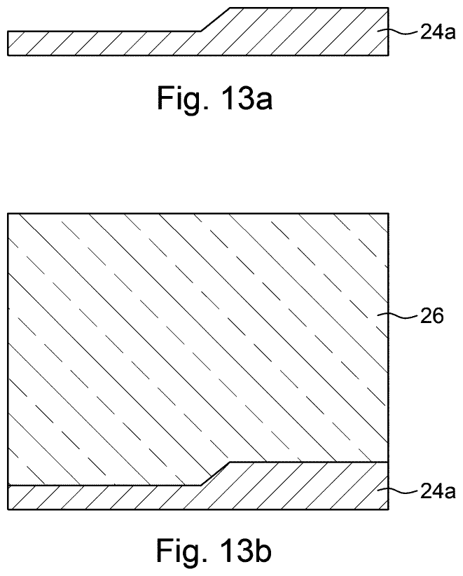

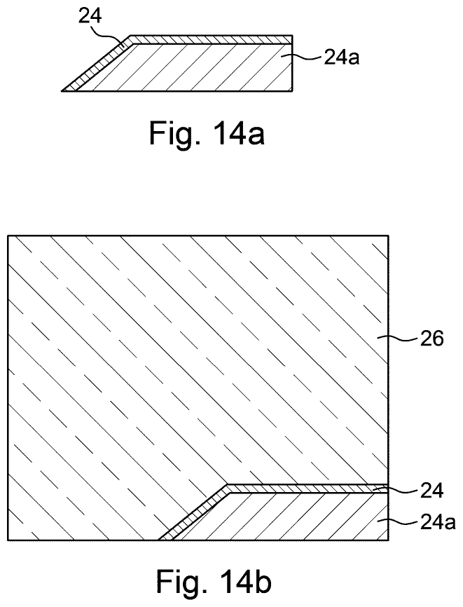

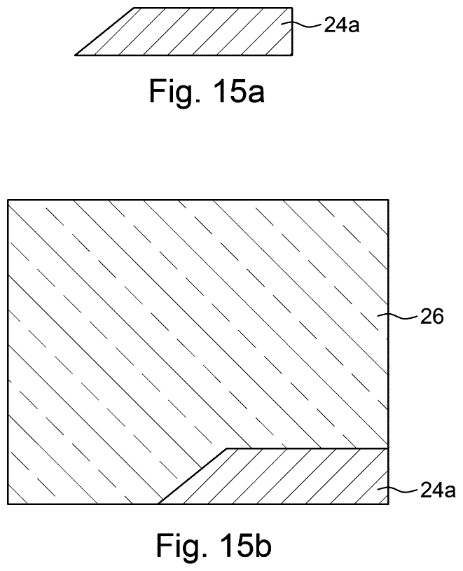

A possible embodiment for producing an optical solid body 10 with at least one structured film 24a with a lower refractive index compared to the transparent injection-molded material of the optical solid body 10 comprises the following steps:
A. Production of at least one structured film 24a with the three-dimensional shape, configuration and/or structure, wherein the at least one film 24a consists of a material or is provided with a layer at least on a surface of the at least one structured film 24a facing the coupling-in portion 16; 16a, 16b of the optical solid body 10, which layer has a lower refractive index than the transparent injection-molded material (cf. FIG. 13a);
B. Insertion of a structured film 24a into the mold and then overmolding at least one side of the film 24a with the transparent material 26 of the optical solid body 10 (cf. FIG. 13b) and, if necessary, inserting and overmolding a further structured film 24a, if present.
C. Optionally, the opposite side of the at least one film 24a could also be overmolded with the transparent material 28 of the optical solid body 10 in a further work step in order to realize a new functionality, as described for example in DE 10 2022 101 928 A1 (not shown). The transparent material 28 preferably has the same refractive index as the transparent material 26 on the opposite side of the at least one film 24a.

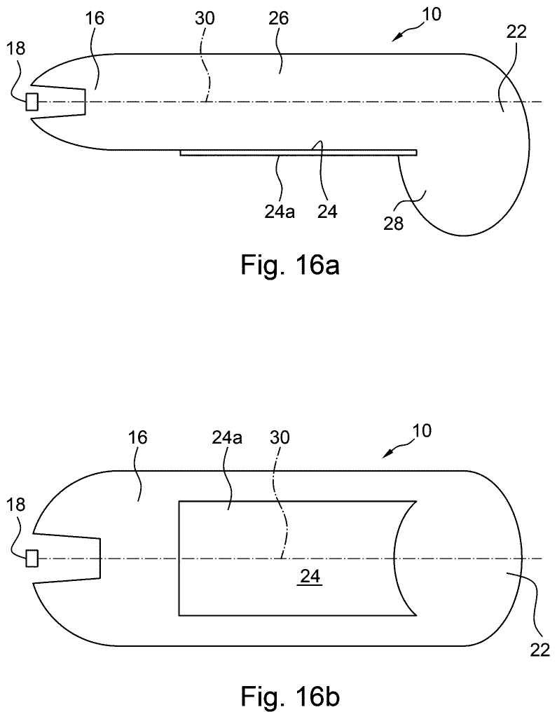

FIGS. 16a and 16b each show an optical solid body 10 with an inserted film 24a with a structuring/metallization along/parallel to the optical axis 30, i.e. on the top and bottom of the film 24a. FIG. 16a shows the metallization in a side view, and FIG. 16b shows the metallization in a plan view.

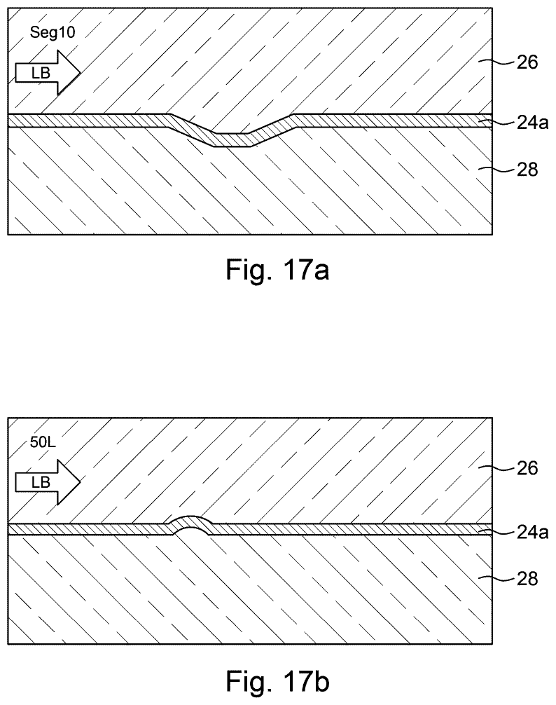

FIGS. 17a and 17b show examples of how the film 24a can be used to realize a specific traffic type with targeted light reduction in the resulting low-beam light distribution (LB) of the light module 12 or the lighting device 14. In this case, targeted lowering, raising or angle changes (cf. FIG. 17a) in the film 24a with respect to a main plane of the reflective surface of the film 24a or a main surface extent of the film 24a enable a targeted reduction of the luminous intensity in regions of legal measuring points, e.g. in order to avoid exceeding the permissible maximum luminous intensity.

In the example in FIG. 17b, absorbent or scattering regions or partially absorbent (one part of the incident light is absorbed, another part is reflected) or partially scattering (one part of the incident light is scattered, another part is absorbed or reflected) regions are introduced into the film 24a in order to reduce the light intensity in the resulting light distribution or to improve or increase illumination in the overhead region.

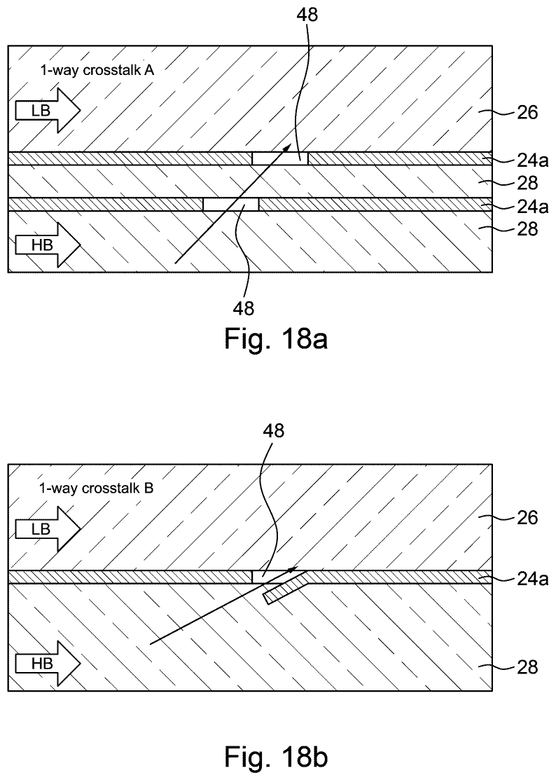

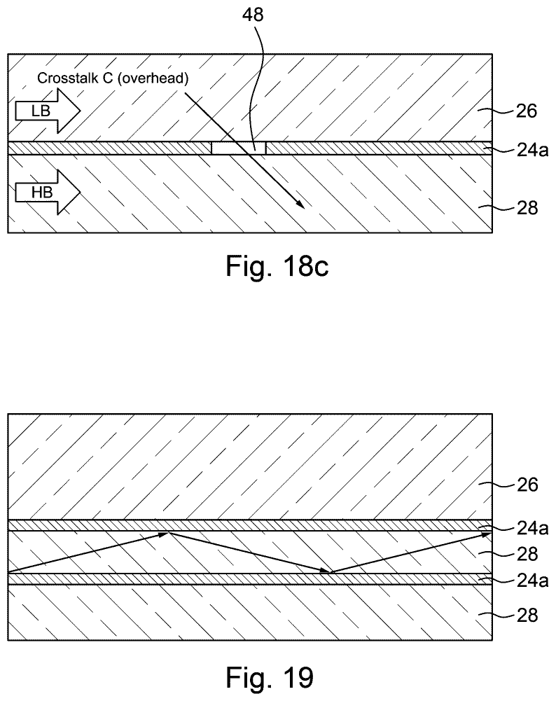

FIGS. 18a to 18c show an embodiment of the invention in which an overhead range or a high-beam (HB) low-beam (LB) transition of the resulting light distribution is influenced. Gaps 48 in the film(s) 24a can allow light to pass into the region that would otherwise not be illuminated or would be less strongly illuminated by the light function of the resulting light distribution. FIGS. 18a and 18b, for example, show how light can pass from the high-beam range (HB) to the low-beam range (LB). For this purpose, the gap 48 or the regions of the film(s) 24a which delimit or define the gap 48 are designed in a particular way so that the light can only pass from the HB to the LB. The particular design comprises, for example, an offset arrangement of gaps 48 in two films 24a introduced into the optical solid body 10 and running parallel to one another (cf. FIG. 18a) or a gap 48, accessible only from one side (on the left in the figure) in a film 24a introduced into the optical solid body 10 (cf. FIG. 18b). On the opposite side (on the right in the figure) the gap is shaded and does not allow access to gap 48.

Furthermore, it would be conceivable for example, that, in the opposite direction as shown in FIGS. 18a and 18b, light from the low beam (LB) reaches the high-beam area (HB) above the light-dark boundary in order to achieve the required minimum luminous intensities there over a large area or at specific measuring points, for example in order to meet legal requirements (cf. FIG. 18c).

FIG. 19 shows an example in which two films 24a metallized on both sides are used, light propagates between the two films 24a in the transition between low beam (LB) and high beam (HB) along the course of the light-dark boundary.

As an alternative to metallization, in the example in FIG. 19 a lower refractive index than the adjacent transparent material 26, 28 of the optical solid body 10 can be provided on the upper side of the upper film 24a and on the underside of the lower film 24a.

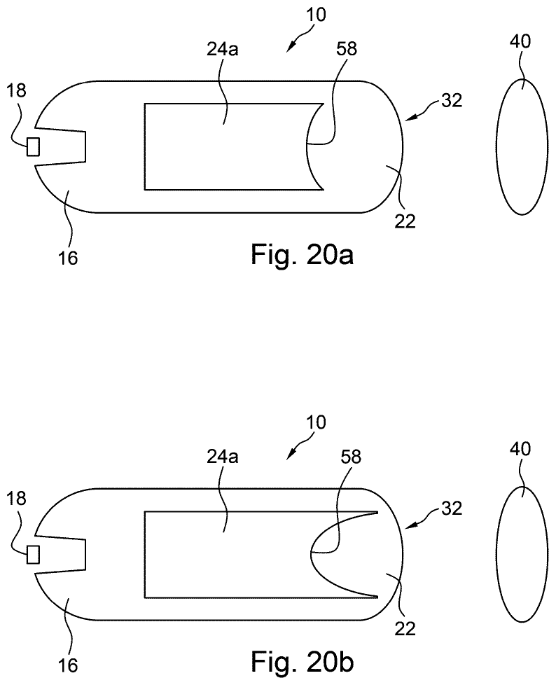

Finally, FIGS. 20a and 20b show an example in which, by using different films 24a, a Petzval adaptation to different distances of the optical solid body 10 or its coupling-out portion 22 to the projection lens 40 can be achieved without the need to produce modified molds or mold inserts. The adaptation is carried out solely by using different films 24a, which differ from one another in particular by the design of one of their edges, in particular the front edge 58. This is also illustrated by the fact that in FIGS. 20a and 20b the outer contours of the optical solid bodies 10 remain the same. The light distribution is only modified by the introduction of another optically active film 24a.

1. An optical solid body made of a solid transparent material for use in a light module of a motor vehicle lighting device, the optical solid body comprising a light coupling-in portion, via which light from a light source of the motor vehicle lighting device can be coupled into the optical solid body, and a light coupling-out portion, via which at least a portion of the light coupled into the optical solid body is coupled out of the optical solid body, so that the coupled-out light serves to generate at least a portion of a light distribution of the motor vehicle lighting device in front of the motor vehicle, and the optical solid body further comprises an optically active layer arranged in the beam path between the coupling-in portion and the coupling-out portion, which layer is designed to modify incident light, wherein the optically active layer comprises at least one film and is arranged inside the optical solid body, wherein, the at least one film has a three-dimensional shape, configuration and/or structure and is overmolded on at least one of its surfaces with the transparent material of the optical solid body.

2. The optical solid body according to claim 1, wherein the design of the three-dimensional shape, configuration and/or structure of the at least one film depends on the type of traffic for which the motor vehicle lighting device comprising the light module with the optical solid body is intended to be used.

3. The optical solid body according to claim 2, wherein the three-dimensional shape, configuration and/or structure is designed for one of the following types of traffic or for realizing one of the following light functions: right-hand traffic, left-hand traffic, targeted reduction of luminous intensity in regions of the light distribution of statutory measuring points, and targeted increase of luminous intensity in regions of a low-beam light distribution above a horizontal light-dark boundary of the light distribution.

4. The optical solid body according to claim 1, wherein the at least one film with the three-dimensional shape, configuration and/or structure has a main surface extent which, in the case of a motor vehicle lighting device mounted in a motor vehicle and having the light module with the optical solid body, runs approximately parallel to a lane on which the motor vehicle is standing or traveling.

5. The optical solid body according to claim 1, wherein the at least one film has such an inherent rigidity that it retains the designed three-dimensional shape, configuration and/or structure into which it was brought before being overmolded with the transparent material and which corresponds to the three-dimensional shape, configuration and/or structure of the overmolded film in the finished optical solid body.

6. The optical solid body according to claim 1, wherein the at least one film is designed as a mirror diaphragm which defines a light-dark boundary of a low-beam light distribution of the motor vehicle lighting device in front of the motor vehicle.

7. The optical solid body according to claim 6, wherein the at least one film has a metallization layer at least on a surface facing the light coupling-in portion.

8. The optical solid body according to claim 1, wherein the at least one film has a lower refractive index than the transparent material of the optical solid body used for overmolding the at least one film.

9. The optical solid body according to claim 8, wherein the at least one film has, at least on a surface facing the light coupling-in portion, a layer with a lower refractive index than the transparent material of the optical solid body used for overmolding the at least one film.

10. The optical solid body according to claim 1, wherein the at least one film is designed to convert light of a first spectrum coupled into the optical solid body wholly or partially into light of another spectrum.

11. A method for producing an optical solid body from a solid transparent material for use in a light module of a motor vehicle lighting device according to claim 1, comprising the following steps,
providing a film with a defined three-dimensional shape, configuration and/or structure;
coating at least a first surface of the film;
inserting the film into a mold; and,
overmolding the first surface of the inserted film with the transparent material of the optical solid body.

12. The method according to claim 11, wherein the first surface of the film is coated with a metallization layer and/or a layer having a lower refractive index than the transparent material used for overmolding the at least one film.

13. The method according to claim 11, wherein after the first surface of the inserted film has been overmolded with the transparent material of the optical solid body, an oppositely situated second surface of the inserted film is also overmolded with the transparent material of the optical solid body.

14. The method according to claim 11, wherein a further film with a three-dimensional shape, configuration and/or structure is placed in the mold on the overmolded transparent material of the optical solid body and is overmolded with the transparent material of the optical solid body on at least one of its surfaces.

15. The method according to claim 11, wherein the three-dimensional shape, configuration and/or structure of the film is defined depending on the type of traffic for which the motor vehicle lighting device, which has the light module with the optical solid body, is intended to be used, in particular for one of the following types of traffic, or for realizing one of the following lighting functions: right-hand traffic, left-hand traffic, targeted reduction of luminous intensity in regions of the light distribution of legal measuring points, and targeted increase of luminous intensity in regions of a low-beam light distribution above a horizontal light-dark boundary of the light distribution.

16. A light module of a motor vehicle lighting device, comprising a light source and an optical solid body, wherein the light source is designed and arranged and aligned with respect to the optical solid body such that it emits light in a main emission direction in the direction of a light coupling-in portion of the optical solid body, and wherein the optical solid body is designed to modify light coupled into the optical solid body via the coupling-in portion using an optically active layer comprising at least one film, onto which at least a portion of the coupled-in light impinges, so that light coupled out via a coupling-out portion of the optical solid body generates at least a portion of a light distribution of the motor vehicle lighting device in front of the motor vehicle, wherein the optical solid body is designed according to claim 1.

17. The light module according to claim 16, wherein the light module has a plurality of light sources and/or a plurality of solid optical bodies.

18. The light module according to claim 16, wherein the light module has a projection lens which is arranged downstream of the coupling-out portion of the optical solid body in the beam path and is designed to image an intermediate image formed in an intermediate image plane, which is preferably arranged in the optical solid body, as the light distribution of the motor vehicle lighting device or as part of the light distribution in front of the motor vehicle.

19. A motor vehicle lighting device, having a housing which has a light exit opening closed by a cover plate and at least one light module inside the housing which projects light in front of the motor vehicle to generate a light distribution of the motor vehicle lighting device or a portion thereof, wherein the at least one light module is designed according to claim 16.
